(19) United States
(12) Patent Application Publication
(10) Pub. No.: US 2009/0326707 A1
(43) Pub. Date: Dec. 31, 2009

(54) USER-PORTABLE RADIO TELEPHONE DELIVERY CONTAINER AND RELATED APPARATUS AND METHOD

(75) Inventor: Mika Mattila, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 12/297,600

(22) PCT Filed: Apr. 4, 2007
(86) PCT No.: PCT/EP07/03080

§ 371 Date: Mar. 5, 2009

(30) Foreign Application Priority Data
Apr. 21, 2006 (GB) 0607912.3

(51) Int. Cl. G06Q 10/00; B65D 85/00; G06F 7/00; G06Q 30/00; G06Q 50/00

(52) U.S. Cl. 700/216; 206/320; 705/26

(57) ABSTRACT

A user-portable radio telephone delivery container (40), the delivery-container comprising: an inner container (42); and an outer container (41) adapted to entirely enclose the inner container, the inner container having one or more compartments defined therein, one compartment adapted to contain a user-portable radio telephone, the outer container (41) being adapted to pass through a predetermined size of opening for postal deliveries at a home of an end user of the user-portable radio telephone.

The invention relates to user-portable radio telephone delivery containers and to related apparatus and methods.

### BACKGROUND OF THE INVENTION

User-portable radio telephones, hereinafter referred to more conveniently as telephones or mobile telephones, are typically presented for sale and/or delivery to an end user in suitable containers such as retail packages. Retail packages typically incorporate a printed branded design on one or more exterior surfaces in order to be more attractive to the end user or purchaser of the telephone. Such a retail package may also be designed and decorated to enhance the “opening experience” for the end user. When mobile telephones are, instead of being purchased in a retail environment, delivered to an end user, the same retail packaging may be used, with the packaging being commonly packed inside a larger outer box for delivery. The outer box provides a degree of security and protection against handling damage. The outer box is also typically relatively plain in visual appearance by comparison with the retail packaging box, so as to reduce the possibility of theft.

For example, a retail package may be decorated with attractive imagery and branded with logos associated with the manufacturer of the telephone within. The package may also be designed such that it is provided with a hinged lid, so that the opening experience for the end user involves attractively presenting the contents to the user in a predetermined arrangement. Within the package, the telephone and its several associated components such as a battery, an electrical charger, an instruction manual and a headset are typically held in various compartments. The end user is then presented with the components in a predetermined way.

Many retail packaging components are typically optimised in various ways, which may depend upon, amongst other things, the number and types of components included with the telephone, as well as the size of the telephone itself, the point of sale environment in which the packaging is to be displayed and the type of branding on the packaging. Little thought, however, is conventionally given to how the end user is to physically receive the telephone. This last point may not be an overriding issue when the end user receives the mobile telephone within its retail packaging in a retail environment, since as long as the user can carry the package away, the size and shape of the package is relatively unimportant.

When products are available for ordering via the internet, delivery of the physical goods being ordered often depends on being able to either: i) have the goods delivered to the purchaser personally due to the size or value of the goods; or ii) being able to fit the packaged goods through a delivery slot, i.e. a letter box, at an address of the purchaser. Being available personally to receive the goods can be an inconvenience for the purchaser, particularly if delivery can only be attempted during normal working hours, when the purchaser may not be at home. Even if deliveries can be made outside of normal working hours, these would tend to be more expensive and there would still be no guarantee that the purchaser will be at home when a delivery is attempted. Many goods are packaged in containers that are too large to be delivered to a purchaser's home letter box, and repeated failed delivery attempts are consequently common, resulting in additional cost and inconvenience.

One possible prior art solution is to package the various components in a padded envelope rather than a rigid container. This approach is, however, generally unacceptable for aesthetic reasons and because a common style of packaging would not be suitable for both delivery and for retail packaging. Additionally, the opening experience for the user would be less desirable, as the various components would be more likely to be jumbled in the envelope, and not presented to the user on opening in an aesthetically pleasing way.

For mobile telephones, since the packaging is typically designed more for attractiveness and the ability to store all the commonly necessary components to be sold with the telephone itself, the retail packaging is invariably too large to fit within a typical delivery slot such as in a home letter box. A problem therefore remains when the mobile telephone is ordered for delivery to the end user, in that the user is inconvenienced when delivery has proved to be not possible. The end user may then have to alternatively: i) be present for another delivery attempt; ii) visit a delivery depot to collect the package, thus causing inconvenience for the user and additional cost for the delivery company; or iii) arrange to have the delivery redirected to the user's work address (which may not be possible).

A further consideration not often taken into account when designing packaging for mobile telephones is that of the environmental impact of the packaging. When the packaging includes moulded plastic parts such as internal partitioning parts to hold the various components, recycling or waste disposal may be more problematic. It would therefore be advantageous to be able to reduce the environmental impact of the packaging used by using fewer packaging components and, where possible, to make the components either biodegradable or readily recyclable. Minimising the overall size and weight of the packaging would also further the aims of having a reduced environmental impact.

### OBJECTS OF THE INVENTION

It is an object of the present invention to solve one or more of the above mentioned problems by providing a user-portable radio telephone delivery container that is adapted to pass through a predetermined size of opening for postal deliveries. Such a delivery container may not only be suitable for postal delivery but also for retail sale/display at a store.

It is a further object of the present invention to provide a user-portable radio telephone delivery container that requires fewer individual parts and has a reduced environmental impact.

### SUMMARY OF THE INVENTION

In a first aspect, the invention provides a user-portable radio telephone delivery container, the delivery container comprising:
an inner container; and
an outer container adapted to entirely enclose the inner container,
the inner container having one or more compartments defined therein, one compartment adapted to contain a user-portable radio telephone,
the outer container being adapted to pass through a predetermined size of opening for postal deliveries at a home of an end user of the user-portable radio telephone.

In a second aspect, the invention provides a blank for the delivery container of the first aspect, the blank comprising a substantially planar unitary piece of packaging material adapted to, when assembled, form a user-portable radio telephone container, the container having one or more compartments defined therein, one of the compartments being adapted to contain a user-portable radio telephone.

In a third aspect, the invention provides a method of delivering a user-portable radio telephone to an end user, the method comprising the steps of:
receiving from a user at a server an order for a user-portable radio telephone, the order comprising a postal address of an end user of the user-portable radio telephone;
transmitting from the server to an order fulfillment facility the postal address of the end user; and
providing at the order fulfillment facility a delivery container containing the user-portable radio telephone, the delivery container comprising:
an inner container; and
an outer container entirely enclosing the inner container,
the inner container having one or more compartments defined therein, one compartment adapted to contain the user-portable radio telephone,
the outer container being marked with the postal address of the end user and being adapted to pass through a predetermined size of opening for postal deliveries at a home of the end user.

In a fourth aspect, the invention provides a server adapted to receive a user portable radio telephone order according to the third aspect.

In a fifth aspect, the invention provides a computer program product, comprising a computer readable medium having thereon computer program code means adapted, when said program is loaded onto a computer, to make the computer execute the procedure of the third aspect.

In a sixth aspect, the invention provides a computer program, distributable by electronic data transmission, comprising computer program code means adapted, when said program is loaded onto a computer, to make the computer execute the procedure of the third aspect.

### BRIEF DESCRIPTION OF THE DRAWINGS

In order that the invention may more readily be understood, a description is now given, by way of example only, reference being made to the accompanying drawings, in which:

FIG. 1 is a drawing of a representative prior art packaging container for a mobile telephone and associated components;

FIGS. 2a to 2c are drawings of an embodiment of the invention for a first size of delivery package;

FIGS. 3a to 3c are drawings of an embodiment of the invention for a second size of delivery package;

FIG. 4 is a drawing of an embodiment of a delivery package of the invention;

FIG. 5 is a drawing of the delivery package of FIG. 4 with a mobile telephone and associated components contained therein;

FIG. 6 is a further drawing of the delivery package of FIG. 4, showing the various associated components;

FIG. 7 is a perspective view of the delivery package of FIG. 4, showing the outer container;

FIG. 8 shows four different designs for the appearance of the inner container of the invention;

FIGS. 9a and 9b show plan views of an inner container comprising adjustable compartments;

FIGS. 10a to 10d show the inner container of FIGS. 9a and 9b with an adjustable mobile telephone compartment in different configurations; and

FIGS. 11a and 11b show the inner container of FIGS. 9a and 9b with an adjustable accessory compartment in different configurations.

### DETAILED DESCRIPTION OF THE INVENTION

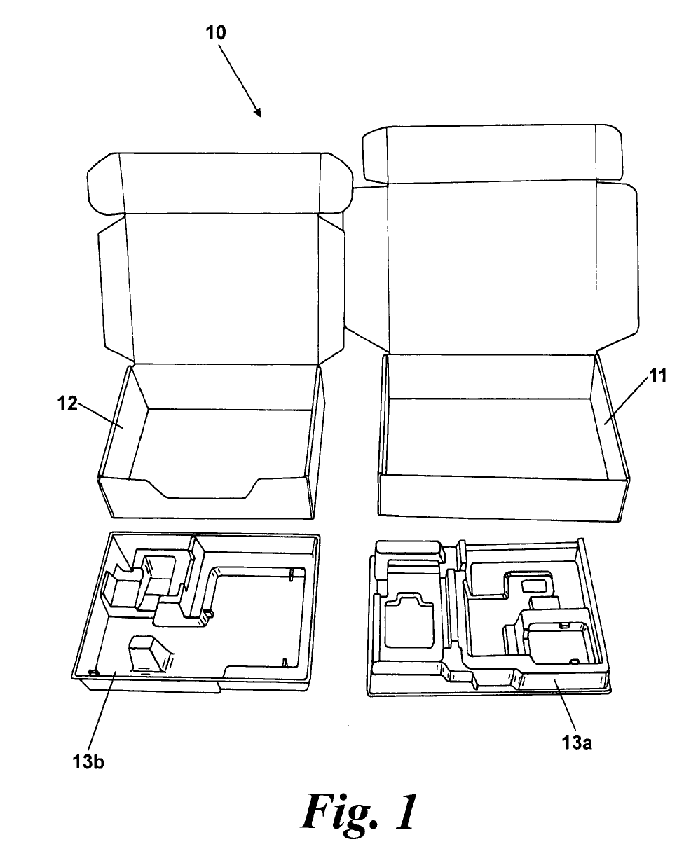

Shown in FIG. 1 is a typical prior art user-portable radio telephone container 10. The container 10 comprises an outer container 11, an inner container 12, and two internal partitions 13a, 13b for dividing the internal volume of the inner container into separate compartments suitable for the various components to be held therein.

The inner container 12 and outer container 11 are both typically of substantially cuboid-shape and fabricated from a packaging board such as cardboard, while the internal partitions may be fabricated from a plastically mouldable material such as polyethylene. The internal partitions 13a, 13b of FIG. 1 may result in an aesthetically unpleasing appearance of the interior of the inner container when opened, due to the first view a user has being the back of a moulding. Also, the partitions are additional components which add to the cost for the overall packaging. Further, the plastics used may not be easily recycled or otherwise readily disposed of in an environmentally benign way.

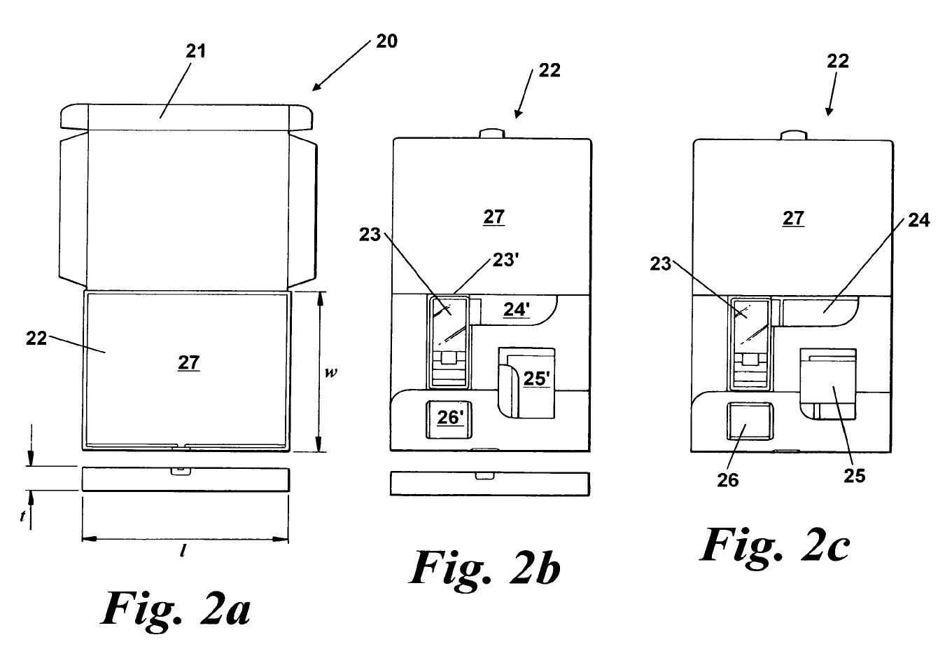

An exemplary embodiment of a design for a user-portable radio telephone delivery container 20 of the invention is shown in FIGS. 2a to 2c. The delivery container 20 comprises two containers: an inner container 22 which is completely encasable by an outer container 21. FIG. 2a shows a plan view of a substantially cuboid-shaped delivery container 20, in a form in which the outer container 21 is open, with the inner container 22 shown therein. The overall dimensions of the outer container, and therefore the overall delivery container, is given in general by a length l, a width w and a thickness t as indicated in FIG. 2a. Preferably, a rectangular cross-section defined by either the length and thickness, i.e. l×t, or by the width and thickness, i.e. w×t, is of a size so as to pass through an opening in a typical letter box. The thickness of the delivery container 20 places a constraint on the design of the internal layout of the inner container 22, shown in FIGS. 2b and 2c, in that all the components to be contained must fit within the required maximum thickness, additionally allowing for the thickness of the walls of the containers.

Various compartments 23′, 24′, 25′, 26′ are formed within the inner container 22 so as to receive respective components 23, 24, 25, 26. FIG. 2b shows a mobile telephone 23 in position within a compartment 23′, while the other compartments 24′, 25′, 26′ are shown empty. This indicates certain structural features of an embodiment of the invention, in that each compartment 23′, 24′, 25′, 26′ is formed from the same material as that defining the inner container 22. The compartments 23′, 24′, 25′, 26′ may be made by folding pre-cut and scored sections of a blank from which the inner container 22 is made. Further, as can be seen in FIGS. 2b and 2c, the various components 23, 24, 25, 26 are arranged to be visible immediately upon opening the lid 27 of the inner container 22.

FIG. 2c shows the various components 23, 24, 25, 26 in place within their respective compartments 23′, 24′, 25′, 26′ in the inner container 22. In addition to the mobile telephone or transceiver unit 23, these components may be, for example, a paper/electronic user guide and/or software stored on a cd-rom 24, a headset 25 and a battery and/or multimedia card (MMC) 26. Other compartments may also or alternatively be envisaged and arranged within the inner container 22 of the invention, depending upon the desired configuration and the requirements of the user. For example, a charger unit and additional connector cables may be omitted from the container 22, due to one or more reasons of: i) size; ii) the user already being in possession of a suitable charger; or iii) the user being able to obtain a charger from elsewhere.

Provided that all the various components can be contained within the required maximum thickness t of the delivery container, a container of the invention can generally be devised that will fit within a predetermined size of opening of a letter box. The maximum dimensions for a delivery container of the invention may be smaller than 250 mm×400 mm×30 mm. Exemplary dimensions for the delivery container 20 of FIGS. 2a to 2c are t=30 mm, w=185 mm and l=225 mm.

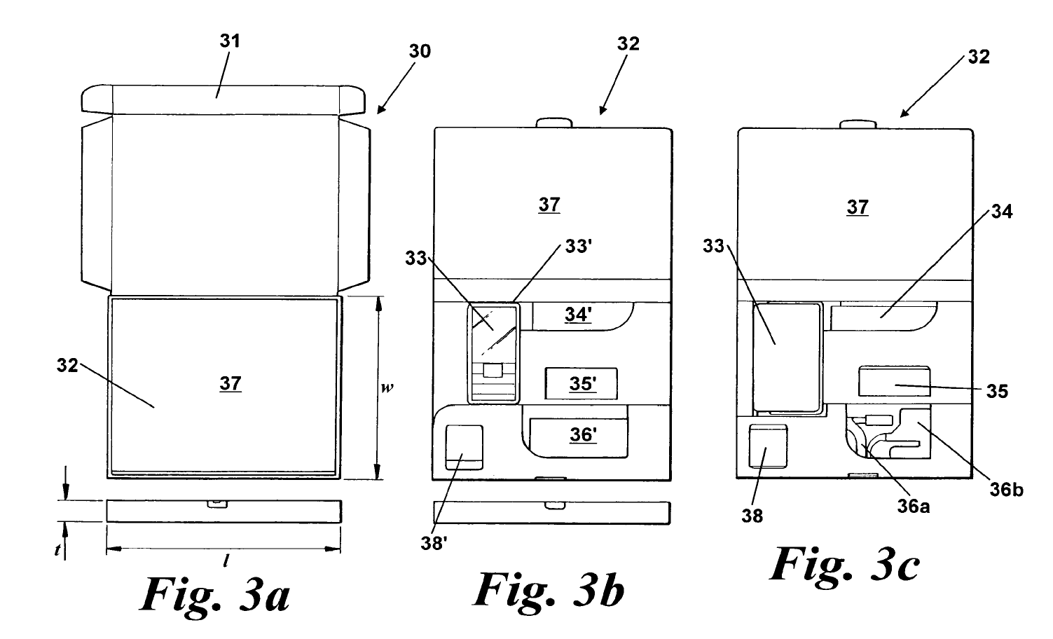

A further exemplary embodiment is shown in FIGS. 3a to 3c, which illustrate a larger version of the type of delivery container shown in FIGS. 2a to 2c. The delivery container 30 again comprises an outer container 31 and an inner container 32, the outer container 30 being defined by dimensions of length l, width w and thickness t. Opening the lid 37 of the inner container 32 reveals, in FIGS. 3b and 3c, various compartments 33′, 34′, 35′, 36′, 38′ defined therein, into which the various respective components 33, 34, 35, 36, 38 can fit. In the example shown, the various components, in addition to the mobile telephone 33, may be a paper/electronic user guide and/or software stored, for example, on cd-rom 34, a headset 35, a battery and/or MMC 38 and a cable and/or charger 36a, 36b. The increased size of the container 30 allows for the accommodation of the cable 36a, and charger 36b in this case, not present in the container 20 of FIGS. 2a to 2c.

To be able to pass through a standard sized opening in a letter box, a cross-section of an outer container of the delivery container of the invention must be smaller than the opening. A maximum package size of, for example, 30 mm×250 mm×350 mm is envisaged be able to fit through a substantial proportion of standard sized letter box openings. The delivery container of the invention is therefore preferably no larger than this maximum package size. Alternatively, the smallest linear dimension t of the delivery container is no greater than approximately 30 mm, so that the container will readily pass through most letter box openings. Exemplary dimensions for the delivery container 30 of FIGS. 3a to 3c are t=30 mm, w=225 mm and l=280 mm, or alternatively t=30 mm, w=185 mm and l=280 mm.

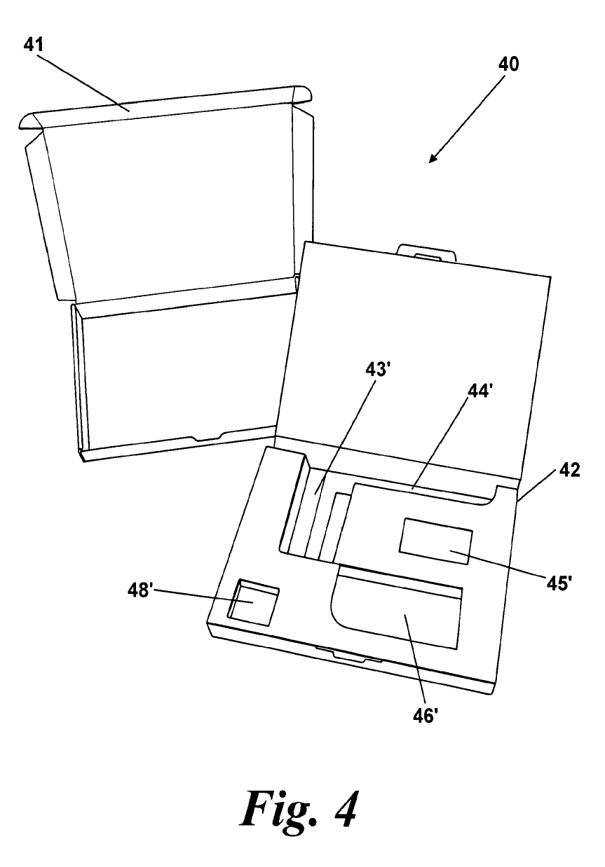

Shown in FIG. 4 is 3-dimensional view of an exemplary embodiment of a delivery container 40 similar to that shown in FIGS. 3a to 3c. The outer container 41 and the inner container 42 are shown separated, and the various compartments 43′, 44′, 45′, 46′, 48′ within the inner container are also shown.

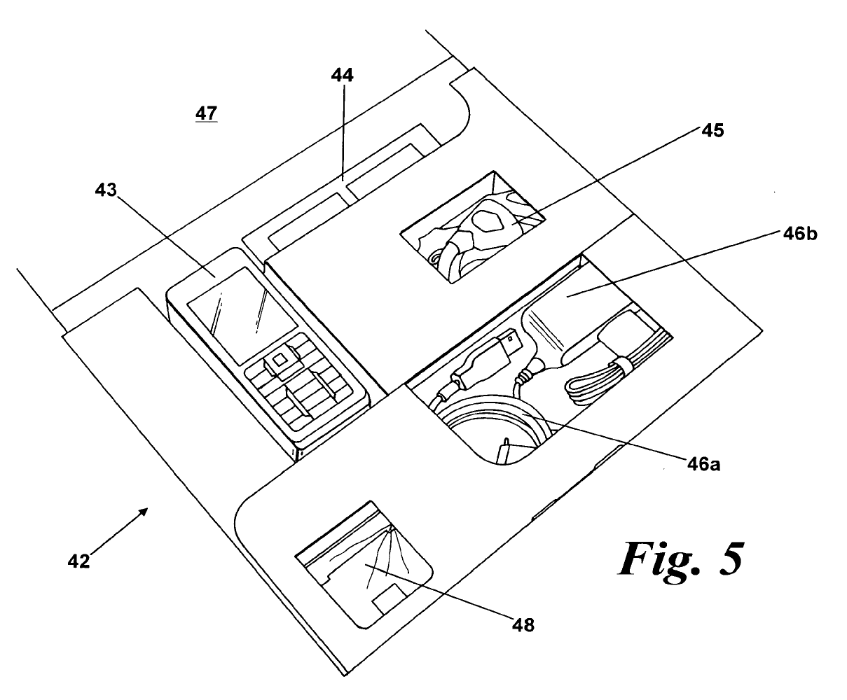

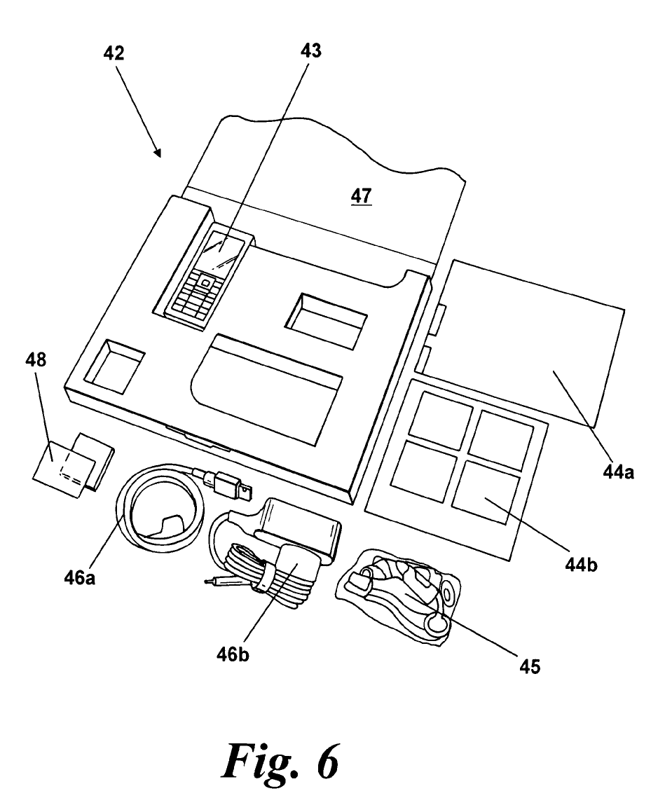

The inner container 42 of the embodiment shown in FIG. 4 is further illustrated in FIG. 5, which shows an exemplary layout of components within the inner container 42 with lid 47 opened. The various components 43, 44, 45, 46a, 46b, 48 are shown within their respective compartments 43′, 44′, 45′, 46′, 48′. These components are further illustrated in FIG. 6, which shows the user manual 44a, cd-rom 44b, headset 45, charger 46b, cable 46a and battery/MMC 48 outside the inner container 42, and the mobile telephone 43 within the container 42.

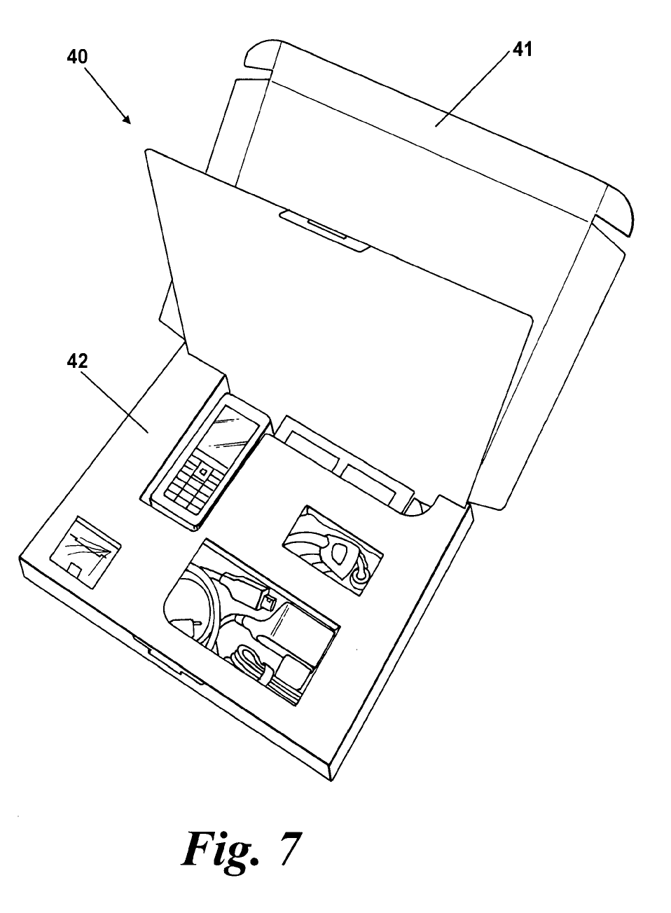

In FIG. 7, delivery container 40 is shown where the inner container 42 is in position within the outer container 41, the view corresponding to that presented to a user upon opening the delivery container 40.

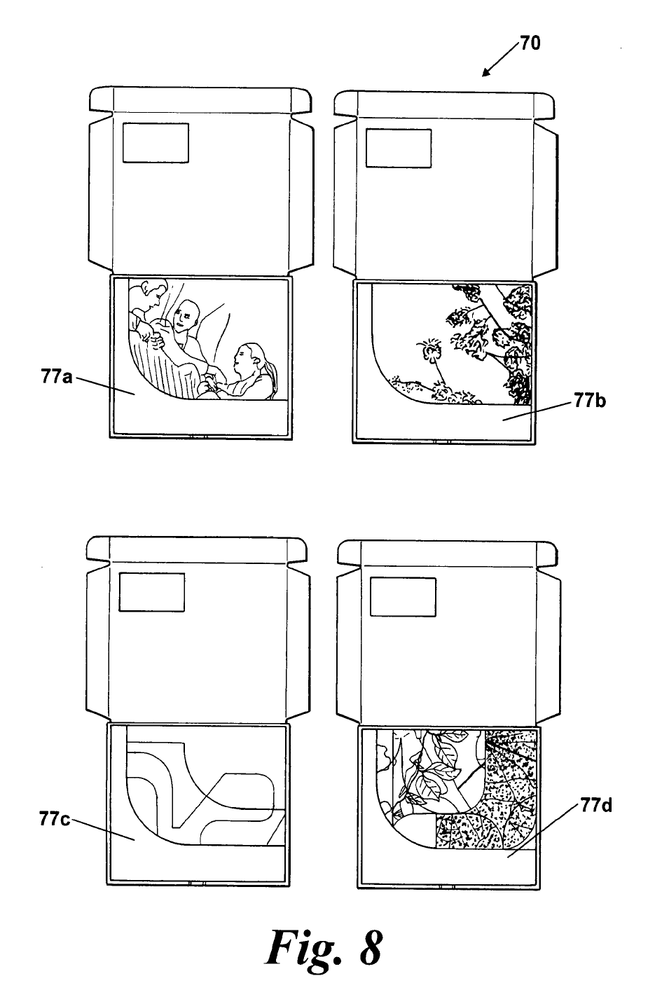

As well as an aesthetically pleasing layout of components within the delivery container 20, 30, 40, one embodiment of the invention allows for different graphical designs to be used on, for example, the external surface of the lid 27, 37, 47 (shown in FIGS. 2, 3, 5 and 6) of the inner container 20, 30, 40. As shown in FIG. 8, an external surface of the inner container lid 77a-d may be provided with various graphical designs, which may have a consistent branded theme. These designs may be printed on to the external surface of the inner container 22, 32, 42 or be adhered to the external surfaces of the inner container 22, 32, 42.

Additionally, the graphical design of the inner container 20, 30, 40 may be chosen or determined by a user, who may for example be a user of an online ordering service for mobile telephones. A user may choose from a selection of graphical designs from an ordering website when choosing the mobile telephone to purchase. Alternatively, the user may choose a personalised graphical design, which may incorporate one or more designs or photographs uploaded from the user to the server of the website. The inner container 20, 30, 40 may then be personalised to the user.

In practice, a user may access a website of a server to browse for a mobile telephone which the user wishes to buy, the website enabling the user to place an order for the mobile telephone. The user may also be able to place an order over the telephone by, for example, calling a call centre. The server may belong to the manufacturer or alternatively to a network operator or another retail operator. After having made a selection, the user transmits an order for the mobile telephone the user wishes to purchase, the order being received by the server. The order may alternatively be received by the server as a result of input by a call centre operator. The order received will comprise, amongst other details, a postal address of an end user of the mobile telephone. The end user may or may not be the same as the user of the website.

After receiving the order from the user, the server transmits, either directly or through an intermediary, details of the order including the postal address of the end user to an order fulfillment facility. The order fulfillment facility may be a separate entity from the server, or may be provided within the same location as the server. The purpose of the order fulfillment facility is to provide the mobile telephone ordered by the user, and optionally to personalise the inner container, and to address the delivery container ready for despatch to the end user.

With the outer container of the delivery container having marked on it the postal address of the end user, and containing the inner container with the mobile telephone (and associated components) ordered by the user, the order fulfillment facility then arranges for the delivery container to be delivered to the end user. The delivery container is then delivered to the home of the end user at the postal address provided by passing the delivery container through an opening for postal deliveries, i.e. a letter box opening.

It is to be understood that the above steps from receiving an order to sending the delivery container for delivery to the home of the end user may be carried out under the control of a suitably programmed computer, which computer may also be the server. The process may thereby be partially or wholly automated once an order has been sent by the user.

Optionally, the order fulfillment facility may be provided by the manufacturer with multiple identical packages of delivery containers containing mobile telephones and associated components. The order fulfillment facility, which may be an operator warehouse (the operator being, for example, a mobile telephone network operator), may then provide personalised items in each delivery container together with the operator's own information and branded literature, in addition to adding the home address details of the end user to the outer container.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims.

The applicant indicates that aspects of the present invention may consist of any such individual feature or combination of features. In view of the foregoing description it will be evident to a person skilled in the art that various modifications may be made within the scope of the invention.

For example, the outer container 21, 31, 41 of the delivery container 20, 30, 40 may be adapted to be weather proof. The outer container 21, 31, 41 may be provided with a plain printed design, for example consisting only of printed information essential for tracking and delivery purposes, while the inner container 22, 32, 42 may be provided with a more elaborate and colourful printed design. Alternatively or additionally, the outer container 21, 31, 41 may be non-branded, while the inner container 22, 32, 42 is branded with one or more indicia of, for example, the manufacturer and/or network operator. The inner container 22, 32, 42 may provide additional structural strength to the outer container 21, 31, 41. The inner container 22, 32, 42 may be in a ‘folder’ configuration, where the inner container is adapted to be opened by means of a hinged lid 27, 37, 47.

The materials from which the delivery container 20, 30, 40 is made may comprise recyclable or recycled materials, and these materials may be substantially entirely paper-based.

The compartments 23′, 24′, 25′, 26′, 33′, 34′, 35′, 36′, 38′ may be designed and made to be modular, i.e. adapted to fit a range of standard size telephones and accessory items. The modularity may be enabled by allowing a blank for an inner container 22, 32, 42 to be folded in a plurality of configurations, so as to accommodate a range of mobile telephones and/or accessories. For example, differently sized compartments within the inner container may be achieved by folding the blank in different configurations.

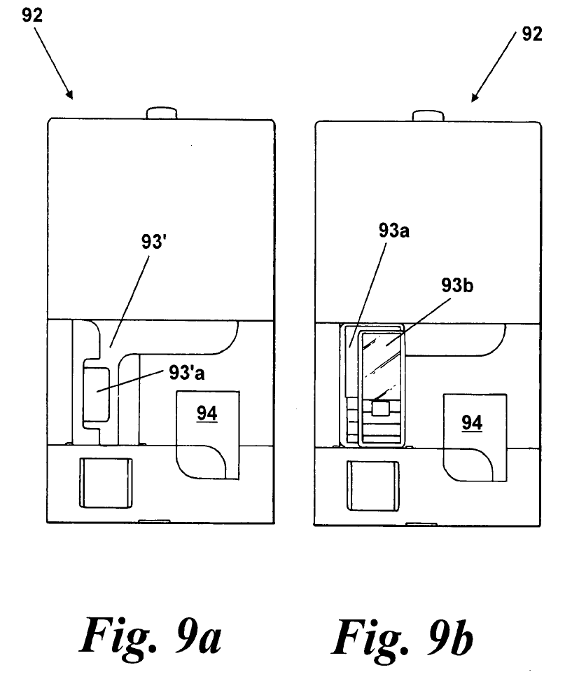

Shown in FIG. 9a is an exemplary inner container illustrating adjustable compartments 93′,94, comprising an adjustable mobile telephone compartment 93′ and an adjustable accessory compartment 94. The mobile telephone compartment 93′ is adjustable by way of a foldable flap 93′a. With the flap 93′a in a closed position, the adjustable compartment 93′ is suitable for receiving a first size of mobile telephone 93a, shown in FIG. 9b. With the flap 93′a in an open position, the adjustable compartment 93′ is suitable for receiving a second smaller size of mobile telephone 93b.

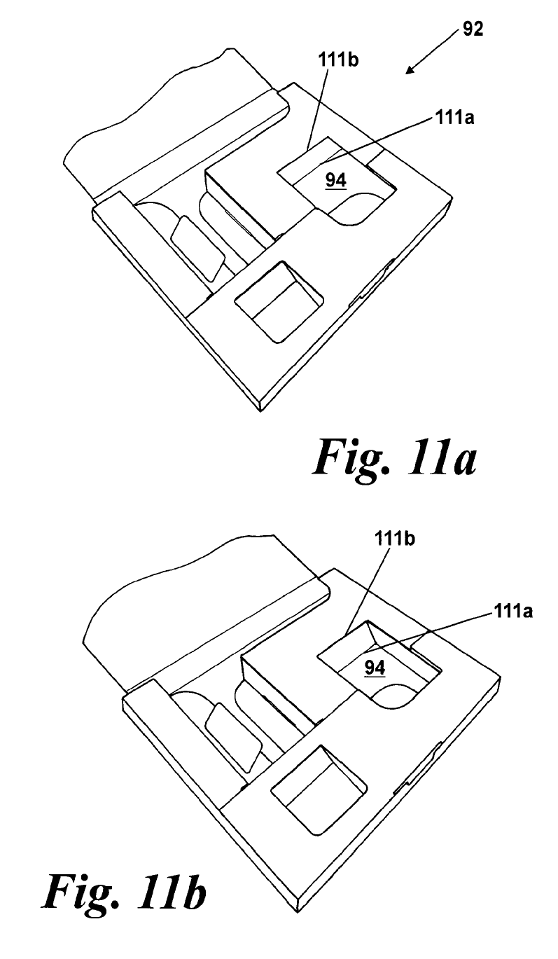

The inner container 92 of FIGS. 9a and 9b further comprises an adjustable accessory compartment 94, the purpose of which is described below in relation to FIGS. 11a and 11b.

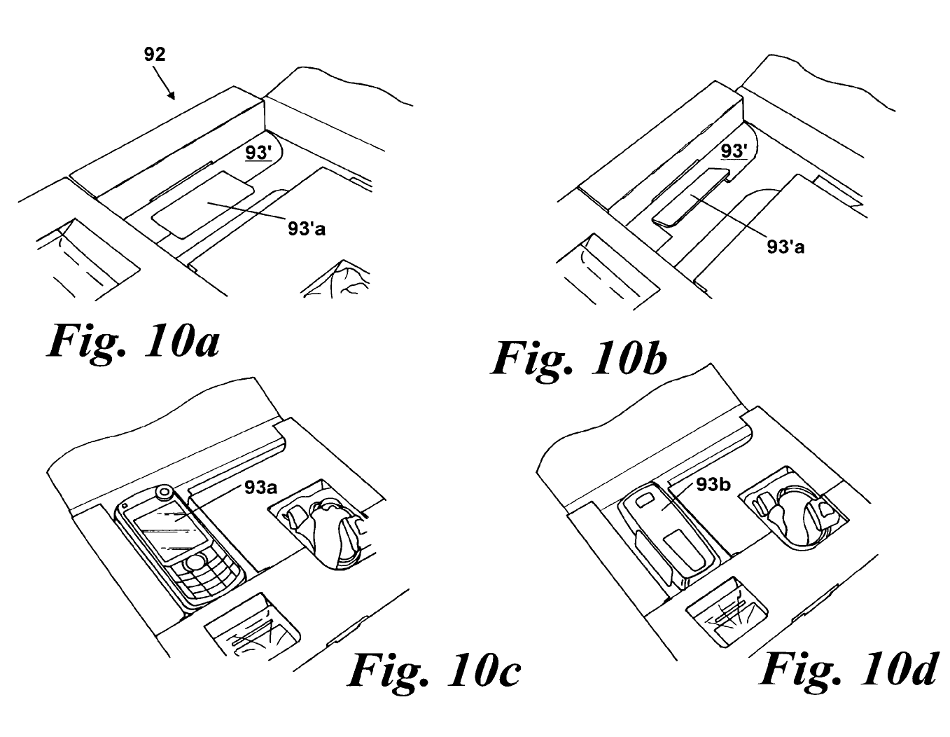

Shown in FIGS. 10a and 10b is the foldable flap 93′a of the adjustable mobile telephone compartment 93′a. In FIG. 10a the foldable flap 93′a is in the closed position, and in FIG. 10b the foldable flap 93′a is in the open position. The compartment 93′ in the closed position is shown in FIG. 10c with a mobile telephone 93a of a first size received therein. The compartment 93′ in the open position is shown in FIG. 10d with a mobile telephone 93b of a second smaller size received therein.

It is to be understood that the mobile telephone compartment 93′ may be adjustable to further accommodate more than two different sizes of mobile telephones 93a, 93b, for example by means of further foldable flaps 93′a therein.

In a general aspect therefore, the inner container 92 is adapted to be adjustable to receive in a compartment 93′ therein one of a selected range of different sizes of mobile telephones. In particular, the compartment 93′ may comprise one or more foldable flaps 93′a to adjust the compartment 93′ for receiving the selected size of mobile telephone.

The inner container 92 may further comprise one or more adjustable accessory compartments 94, as shown in FIGS. 9a and 9b, and in FIGS. 11a and 11b. In FIG. 11a the adjustable compartment 94 is shown in a closed configuration. This closed configuration is, for example, suitable for when an open compartment is not required for a particular accessory, which is not to be included within the delivery container. Shown in FIG. 11b is the adjustable compartment 94 in an open configuration. The compartment 94 is then suitable for receiving one or more particular accessories for the mobile telephone to be contained within the inner container 92. The compartment 94 may be formable from the closed configuration to the open configuration by being folded along crease lines 111a, 111b.

In a general aspect therefore, the inner container comprises one or more adjustable compartments 94, the compartments 94 being configurable in a closed configuration and an open configuration, the open configuration adapted to receive one or more accessories therein.

1. A user-portable radio telephone delivery container, the delivery container comprising:
an inner container; and
an outer container adapted to entirely enclose the inner container,
the inner container having one or more compartments defined therein, one compartment adapted to contain a user-portable radio telephone,
the outer container being adapted to pass through a predetermined size of opening for postal deliveries at a home of an end user of the user-portable radio telephone.

2. The delivery container of claim 1 wherein the outer container is of a substantially cuboid shape.

3. The delivery container of claim 1 wherein the inner container and the one or more compartments defined therein are formed from a unitary piece.

4. The delivery container of claim 3 wherein the unitary piece comprises a substantially planar blank of packaging material.

5. The delivery container of claim 4 wherein the unitary piece is adapted to be folded in a plurality of configurations.

6. The delivery container of claim 1 wherein the inner container is adapted to be adjustable to receive in a compartment therein one of a selected range of different sizes of mobile telephones.

7. The delivery container of claim 6 wherein the compartment comprises one or more foldable flaps to adjust the compartment for receiving a selected size of mobile telephone.

8. The delivery container of claim 1 wherein the one or more of the compartments are configurable in either of a closed configuration and an open configuration, the open configuration being adapted to receive one or more accessories therein.

9. The delivery container of claim 8 wherein the one or more compartments are formable between the closed configuration and the open configuration by folding along one or more crease lines.

10. A blank for the delivery container of claim 1, the blank comprising a substantially planar unitary piece of packaging material adapted to, when assembled, form a user-portable radio telephone container, the container having one or more compartments defined therein, one of the compartments being adapted to contain a user-portable radio telephone.

11. A method of delivering a user-portable radio telephone to an end user, the method comprising the steps of:
receiving from a user at a server an order for a user-portable radio telephone, the order comprising a postal address of an end user of the user-portable radio telephone;
transmitting from the server to an order fulfillment facility the postal address of the end user; and
providing at the order fulfillment facility a delivery container containing the user-portable radio telephone, the delivery container comprising:
an inner container; and
an outer container entirely enclosing the inner container,
the inner container having one or more compartments defined therein, one compartment adapted to contain the user-portable radio telephone,
the outer container being marked with the postal address of the end user and being adapted to pass through a predetermined size of opening for postal deliveries at a home of the end user.

12. The method of claim 11 further comprising the step of sending for delivery the delivery container containing the user-portable radio telephone to the home of the end user.

13. The method of claim 11, the method further comprising the step of accessing by the user a website of the server, the website being adapted to receive the order from the user.

14. The method of claim 11, the method further comprising delivering the delivery container at the home of the end user, delivering the delivery container comprising passing the delivery container through an opening for postal deliveries at the home of the end user.

15. A server adapted to receive a user portable radio telephone order according to claim 11.

16. A computer program product, comprising a computer readable medium having thereon computer program code means adapted, when said program is loaded onto a computer, to make the computer execute the procedure of claim 11.

17. A computer program, distributable by electronic data transmission, comprising computer program code means adapted, when said program is loaded onto a computer, to make the computer execute the procedure of claim 11.

18. A user-portable radio telephone delivery container substantially as described herein with reference to FIGS. 2 to 11.
